(19) United States
(12) Patent Application Publication
(10) Pub. No.: US 2002/0198003 A1
(43) Pub. Date: Dec. 26, 2002

(54) Method and apparatus for creating and presenting a location dependent communication with an electronic device

(76) Inventor: Matthew H. Klapman, Northbrook, IL (US)

Correspondence Address: MOTOROLA INC, 600 NORTH US HIGHWAY 45, LIBERTYVILLE, IL, 60048-5343, US

(21) Appl. No.: 09/885,659

(22) Filed: Jun. 20, 2001

(51) Int. Cl. H04Q 7/20

(52) U.S. Cl. 455/456; 455/414; 455/12.1

(57) ABSTRACT

Multimedia messages, including video, audio, text, and alarms, are presented on an electronic device (102) in response to an electronic device arriving at a particular location. These location dependent communications are created by a user of an electronic device and stored in the electronic device or a communication system (100) associated with the electronic device. The parameters associated with the location dependent communication include a location (300), the form and content of the location dependent communication (302), a device associated with the location (306), a device for receiving the location dependent communication (304), and other options (308), such as a time, a temperature, a speed, or a profile. The location dependent communication is presented on an electronic device when a device associated with the location dependent communication reaches the particular location (402. 404). Arrival at a location is determined by location determination technology, such as satellite based location determination, cell site location determination, inertial sensing, or the like.

### BACKGROUND OF THE INVENTION

The invention generally relates to communication systems, and specifically to location-enabled communication systems that present messages based upon the location of a user.

Communication systems that include the capability to determine the location of portable units are known. In particular, recent government mandates, principally for emergency service, require wireless telecommunications system providers to be able to locate wireless subscriber units within a predetermined area of certainty. This capability is made possible by advancements in satellite positioning systems, and radio frequency based location determination.

Presently, the exploitation of location based data is limited to simply determining location. For example, waypoints are used in a global positioning system to simply alert a user when the global positioning system device reaches a particular location. Also, location data is used to determine a location of a user for a response in an emergency situation. However, these uses for location based data do not fully enable the user to exploit the location data in an expanded manner to flexibly meet the needs of the user.

Therefore, a need exists for improved utilization of location based data in a communication system.

### BRIEF DESCRIPTION OF THE DRAWINGS

FIG. 1 is a block diagram of a preferred embodiment of a communication system that is location-enabled in accordance with the present invention

FIG. 2 is a block diagram of a preferred embodiment of an electronic device that is location-enabled in accordance with the present invention.

FIG. 3 is a flow chart illustrating a preferred method for creating a location dependent communication in accordance with the present invention.

FIG. 4 is a flow chart illustrating a preferred method for presenting a location dependent communication in accordance with the present invention.

### DESCRIPTION OF THE PREFERRED EMBODIMENTS

In summary, a method for creating a location dependent communication for subsequent presentation on an electronic device includes the steps of: (1) selecting a location to be stored and associated with the location dependent communication; (2) selecting a form and content of the location dependent communication; and (3) storing the location dependent communication, the location, and the form and content of location dependent communication in a database. Preferably, selecting a location is accomplished by selecting a current location of the electronic device, by entering a coordinate and/or radius, by selecting a location from a database of stored locations, or by entering an address, zip code, landmark, cell site, or other geographical identifier.

Any electronic device may be selected to receive the location dependent communication. And, any electronic device may be associated with the location of the location dependent communication. This allows an electronic device to receive a location dependent communication that is dependent upon the location of another electronic device. The location dependent communication is stored on the electronic device and/or in a network associated with the electronic device.

The selection of the form and content of the location dependent communication includes selecting video, audio, a text message, an audible alarm or a tactile alert.

After the location dependent communication is created, it is stored on the electronic device where created, sent to another electronic device, or stored in the network associated with the electronic device, or a combination of these.

A method for presenting a location dependent communication on an electronic device includes the steps of: (1) determining a current location of the electronic device; (2) determining whether the location matches a stored location associated with a location dependent communication; and (3) presenting the location dependent communication if the current location matches a stored location associated with a location dependent communication. The location dependent communication communicates more than that the location has simply been reached. The additional information communicated may be video, audio, text, audible alarms, tactile alerts or a combination of these.

Preferably the step of determining the location of the electronic device includes satellite-based location determination, cell site location, or inertial sensing. Location determination is alternatively accomplished in the electronic device itself or in a network associated with the electronic device or a combination of these.

A database of location dependent communications includes a stored location associated with each location dependent communication. The database is alternatively on the electronic device or in a network associated with the electronic device or a combination of these. The stored location relates to a coordinate, a coordinate and radius, a zip code, an address or another geographical identifier.

An apparatus for implementing the methods described above includes a processor and a memory for storing a program that is executed by the processor to control the creation and presentation of a location dependent communication. A location determining circuit is provided to determine a location of the apparatus. An audio processing circuit makes an audible portion of the location dependent communication audible. Similarly, a display makes a visual portion of the location dependent communication visually perceptible. A network interface is provided to couple the apparatus to a network that alternatively stores the location dependent communication, determines the location of the apparatus, or transmits the location dependent communication. Preferably the apparatus is portable.

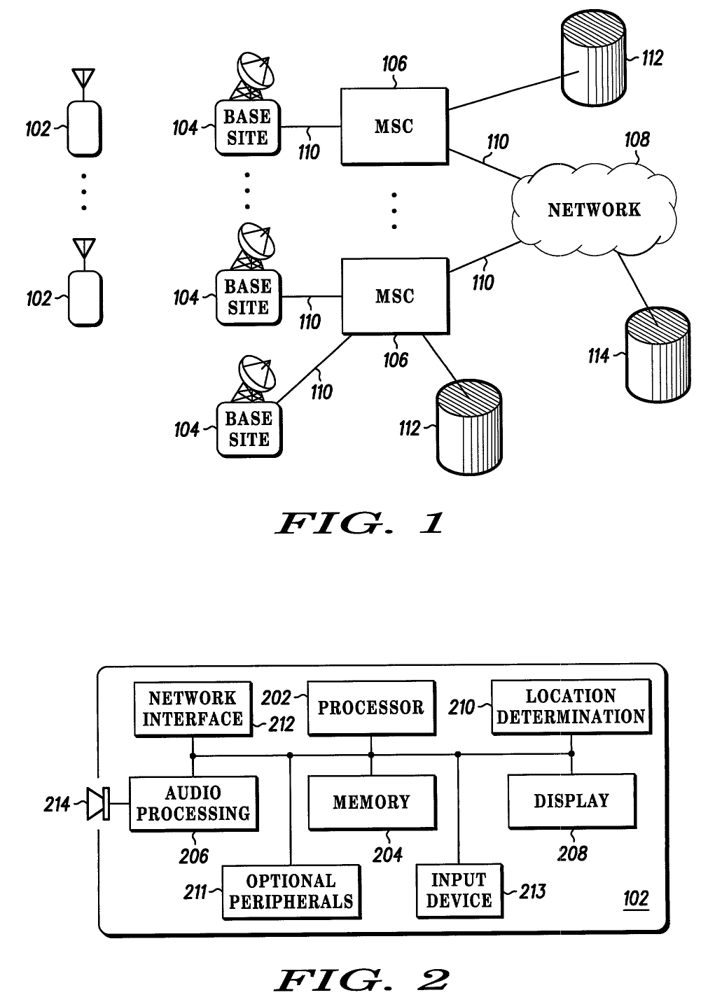

Referring now to the figures, FIG. 1 is a block diagram of a preferred embodiment of a communication system 100 in accordance with the present invention. System 100 includes wireless electronic devices 102 and radio base sites 104. Preferably, wireless electronic devices 102 communicate over the air with base sites 104. More specifically, wireless electronic devices 102 and base sites 104 use a radio frequency communications channel to communicate data, for example, audio, video and other data, to and from each other and to other elements coupled to communication system 100.

Base sites 104 are preferably radio frequency transmitters and receivers that communicate with wireless electronic devices 102. In addition, base sites 104 are preferably connected to mobile switching centers 106 to facilitate the transmission of data to a network 108. Mobile switching centers 106 coordinate, establish and maintain communications with base sites 104 and provide an interface to network 108. Network 108 is, for example, a public telephone network or a data network, such as the Internet. Communication links 110 couple mobile switching centers 106 to base sites 104 and to network 108. Any suitable communication links or trunks suffice for communication links 110. Preferably, mobile switching centers 106 are coupled to databases 112. Also, a database 114 may be associated with and accessed by elements on network 108.

In accordance with the present invention, location dependent communications, which may include video, audio, text, audible alarms, visual alerts, and tactile alerts, are created, stored and presented in communications system 100 based at least on the location of a particular electronic device 102

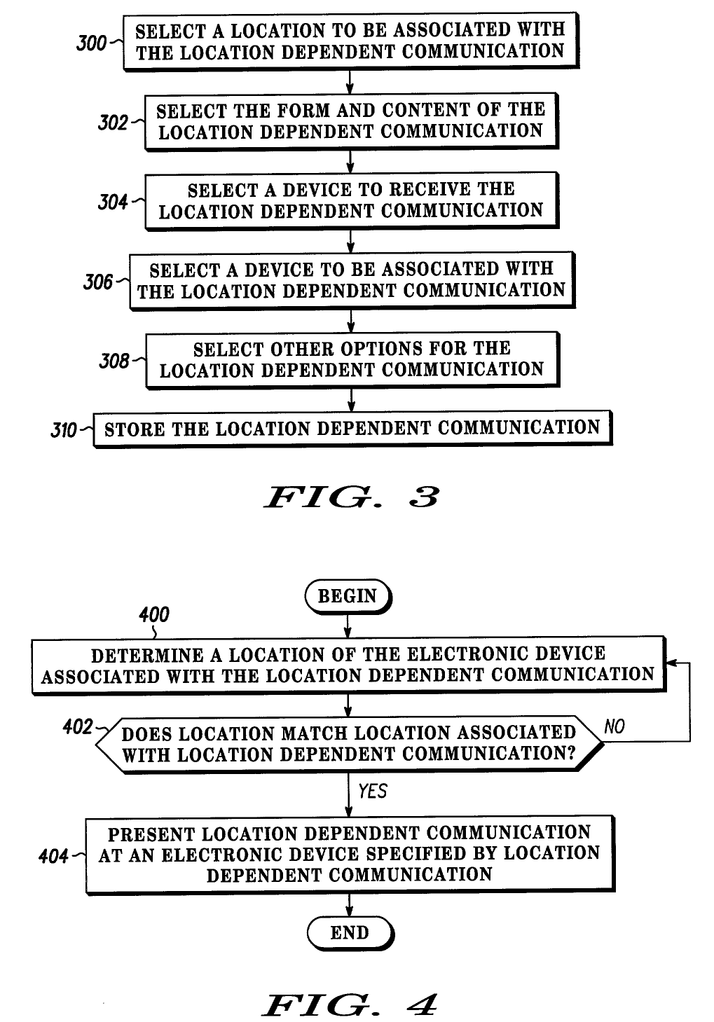

FIG. 2 is a block diagram of electronic device 102 in accordance with the present invention. Electronic device 102 is preferably a portable, wireless electronic device, such as a personal digital assistant, a wireless telephone, a wireless terminal, a computer, or the like. Preferably electronic device 102 includes a processor 202, a memory 204, an audio processing circuit 206, a display 208, a location determining circuit 210, a network interface 212 and an input device 213. These components are coupled together for communication. In particular, processor 202 executes a program stored in memory 204 to create and present location dependent communications on the electronic device 102. The location dependent communication is presented audible by audio processing circuit 206 and speaker 214 and/or visually on display 208. Location determining circuit 210 is used to determine a location of the electronic device. Network interface 212 is used to couple electronic device 102 with a network for communication with network elements and other electronic devices. User input is obtained using input device 213. Optional peripherals 211 are optionally coupled to communicate with the other components of device 102 to provide additional functions, such as, temperature sensing and speed or acceleration sensing.

Processor 202 is any suitable processor that executes stored programs and is capable of controlling peripheral components, such as memory 204, audio processing circuit 206, display 208, location determining circuit 210, network interface 212 and input device 213. Preferably, processor 202 is one or more microprocessors, microcontrollers, digital signal processors or the like.

Memory 204 is any suitable storage device or devices, including volatile or non-volatile memory. Memory 204 stores programs for execution by processor 202. Memory 204 preferably stores a database of location dependent communications.

Audio processing circuit 206 is any suitable audio circuit that converts digital audio to an audible format. The audible format is made audible by speaker 214. Similarly, display 208 is any suitable visually perceptible component, such as, for example, a liquid crystal display, that displays text and images, preferably including motion video images.

Location determining circuit 210 is any suitable circuit capable of determining a location of electronic device 102. Preferably, location determining circuit 210 includes satellite based location determination, cell site based location determination, inertial sensing, or a combination of these. More specifically, location determining circuit 210 preferably includes global positioning system (GPS) logic, radio frequency triangulation logic, and/or inertial sensors that detect relative movement of electronic device 102.

Network interface 212 is any suitable circuit for providing communication between electronic device 102 and communication system 100. Preferably, network interface 212 is a wireless interface, such as a radio frequency interface or an optical interface. In alternate preferred embodiments of the invention where electronic device 102 does not include a location determining circuit, network interface 212 provides an interface to electronic device 102 to receive location data from the associated network.

Input device 213 is any suitable component(s) that receives user input. Preferably, input device 213 is a keyboard. Alternatively, input device 213 is a microphone, touch screen, mouse or the like.

Optional peripherals 211 are any suitable circuits and components for auxiliary functions. In a preferred embodiment, optional peripherals 211 include a temperature sensor and an accelerometer. The temperature sensor senses ambient temperature. The accelerometer senses a speed or acceleration of the device 102.

FIG. 3 is a flow chart illustrating a preferred method for creating a location dependent communication for subsequent presentation on an electronic device in accordance with the present invention. The method is described below with reference to the preferred embodiments shown in FIG. 1 and the FIG. 2.

First, a location is preferably selected that will be associated with the location dependent communication (300). The location itself is alternatively a coordinate, a coordinate and a radius, an address, a cell site, or any other geographical identifier, including a customizable, selectable geographical identifier. The selection of the location is preferably made on any electronic device 102 and is alternatively made using any network element, for example, mobile switching center 106. Preferably, the location is selected by entering a geographical identifier, for example, a coordinate or zip code, or by selecting a current location, or a location from a database of stored locations, or a generic type of location, for example, a gas station or grocery store.

In addition to selecting a location for the location dependent communication (300), the form and content of the location dependent communication is selected (302). The location dependent communication is alternatively a text message, such as an email, a video message, an audio message, an audible or visual alarm, or a tactile alert, such as a vibration of electronic device 102. In accordance with the present invention, the location dependent communication includes more than a simple notification that a location has been reached. For example, a location dependent communication that identifies the grocery store as the location, may include a text message to “buy milk” upon reaching a vicinity of the grocery store.

Preferably, any electronic device 102 is selected to receive the location dependent communication (304). And, any electronic device 102 is selected to be associated with the location (306). Advantageously, this permits one electronic device to receive a location dependent communication when another electronic device reaches a particular location. Of course, the electronic device that receives the location dependent communication may also be the same device that is associated with the location. For example, a first user may create the grocery store (“buy milk”) location dependent communication discussed above and send that location dependent communication to a second user who the first user associated with the location dependent communication such that when the second user is in the vicinity of the grocery store, the second user receives the text message to “buy milk.” The devices are identified in any suitable manner, including for example, by a network identifier, such as a telephone number, where network 108 is a telephone network, or an IP address, where network 108 is the Internet.

Preferably, other options may be selected to be associated with the location dependent communication (308). For example, a time is preferably associated with the location dependent communication. This permits selecting presentation of the location dependent communication as a function of both location and time. For example, the grocery store location dependent communication (“buy milk”), discussed above, may be limited to presentation only during the hours in which the grocery store is actually open. Other options for inclusion with the location dependent communication include a temperature or a speed of the device. Temperature is alternatively used, for example, to present the location dependent communication depending on a particular temperature, which may indicate whether a user is inside or outside. The speed is alternatively used, for example, to present the location dependent communication depending on a particular speed of travel, which may indicate whether a user is walking or riding. The speed is also alternatively used to extend or retract a radius associated with a location, such that, for example, a boundary associated with a location is in part defined by the speed of travel of the device.

Also, a user may combine device profiles, user selectable attributes, with the location dependent communication. For example, a user with a business and personal profile for the electronic device alternatively associates one of the profiles with location dependent communications such that only business related location dependent communications are presented when the business profile is active on the electronic device and location dependent communications related to personal matters are presented only when the personal profile is active on the device.

Parameters to be associated with a location dependent communication are selected in any order desired. In addition, default and global settings are preferably used. The global and default settings are preferably based on the features of the electronic device, such as location determination features and limitations and the like.

After the parameters for the location dependent communication are selected (300, 302,304,306,308), the location dependent communication is stored (310). Preferably, the location dependent communication is stored in a database on electronic device 102 or in network 108. The location dependent communication is preferably stored on the electronic device associated with the location.

FIG. 4 is a flow chart illustrating a preferred method for presenting a location dependent communication in accordance with the present invention. First a location of the electronic device associated with the location dependent communication is determined (400). This is preferably accomplished using location determining circuit 210 on electronic device 102. Alternatively, the location is determined by elements of communication system 100, including for example a mobile switching center 106 that has location information that is determined based on a location associated with a transmission from the electronic device 102. In other words, the electronic device 102 internally determines its location or a network associated with the electronic device 102 determines its location, in part based on the location of communications associated with the electronic device. The location is alternatively determined periodically or as a result of a change of location.

After the location of the electronic device associated with the location dependent communication is determined (400), then that present location is compared to a location associated with a location dependent communication (402). In other words, a determination is made as to whether the electronic device is at a location associated with a location dependent communication. Where the location dependent communication is stored on electronic device 102, processor 202 of electronic device 102 preferably makes this determination. In the case where the location dependent communication is stored in an element of communication system 100, the electronic device 102 preferably communicates its location to that network element, which then determines whether the electronic device is at a location associated with a location dependent communication. Preferably, where the location determination logic is in communication system 100, the determination of whether the present location matches a location associated with a location dependent communication is made in the element with the location determination logic.

If the present location of the electronic device does not match a location associated with the location dependent communication, then no action is required. If, on the other hand, the present location of the electronic device does match a location associated with the location dependent communication, then the location dependent communication is presented in accordance with the form and content previously stored with the location dependent communication (404). Other options may need to be determined before presentation of the location dependent communication. For example, if time is associated with the location dependent communication, then in addition to determining whether the present location matches a location associated with the location dependent communication, a time must also be considered for determining whether the present time matches a time associated with the location dependent communication.

The location dependent communication is presented at the electronic device specified by the location dependent communication. In a preferred embodiment, where the electronic device specified to receive the location dependent communication is different from the electronic device associated with the location, an electronic message is sent from the electronic device associated with the location to the electronic device specified to receive the presentation. The message may include the actual form and content of the location dependent communication. In the case where the network stores the location dependent communication, the network communicates the location dependent communication to the electronic device that is specified to receive the presentation in any appropriate manner. For example, where network 108 is the Internet, a packet or packets may be sent to an electronic device, including the form and content of the location dependent communication.

In accord with the present invention, location dependent communications are created and presented on a portable electronic device. The customizable location dependent communications permit users to exploit location determination technology in new, useful an exciting ways.

Whereas the present invention has been described with respect to specific embodiments thereof, it will be understood that various changes and modifications will be suggested to one skilled in the art and it is intended that the invention encompass such changes and modifications as fall within the scope of the appended claims.

1. A method of presenting a location dependent communication with an electronic device, the method comprising the steps of:
determining a location of the electronic device;
determining whether the location matches a stored location associated with a location dependent communication; and
presenting the location dependent communication, if the location matches the stored location, wherein the location dependent communication communicates more than that the location has been reached.

2. The method of claim 1 wherein the step of determining the location of the electronic device includes determining location using at least one of satellite-based location determination, cell site location and inertial sensing.

3. The method of claim 1 wherein the location comprises a coordinate.

4. The method of claim 1 wherein the stored location is stored in the electronic device.

5. The method of claim 1 wherein the stored location is stored in a network that is coupled to the electronic device.

6. The method of claim 1 wherein the location comprises a coordinate and a radius extending from the coordinate.

7. The method of claim 1 wherein the stored location dependent communication is stored in the electronic device.

8. The method of claim 1 wherein the stored location dependent communication is stored in a network coupled to the electronic device.

9. The method of claim 1 wherein the location dependent communication includes at least one of video, audio, a text message, an audible alarm, and a tactile alert.

10. The method of claim 1 wherein the location dependent communication is presented at another electronic device remote from the electronic device.

11. A method for creating a location dependent communication for subsequent presentation on an electronic device, the method comprising the steps of:
selecting a location to be stored and associated with the location-dependent communication; and
selecting a form and content of the location dependent communication; and
storing the location dependent communication, the location and the form and content of the location dependent communication in a database.

12. The method of claim 11 wherein the location is selected by selecting a current location of the electronic device.

13. The method of claim 11 wherein the location is selected by entering at least one of a coordinate and a radius.

14. The method of claim 11 wherein the location is selected by entering at least one of an address, zip code, landmark and cell site.

15. The method of claim 11 wherein the location is selected from a database of known locations.

16. The method of claim 11 further comprising the steps of:
selecting a first electronic device to receive the location dependent communication;
selecting a second electronic device to be associated with the location; and
storing an indication of the first electronic device and the second electronic device in the database.

17. The method of claim 11 wherein the database is located on an electronic device.

18. The method of claim 11 wherein the database is stored in a network associated with the electronic device.

19. The method of claim 11 wherein the step of selecting a form and content of the location dependent communication includes selecting at least one of video, audio, a text message, an audible alarm, and a tactile alert.

20. The method of claim 11 further comprising the step of:
sending the location dependent communication, the location and the form and content of the location dependent communication to another electronic device.

21. The method of claim 11 further comprising the step of selecting at least one of a time, a temperature, a speed, and a profile to be associated with the location dependent communication.

22. An electronic device that presents a location dependent communication comprising:
a location determining circuit that determines a location of the electronic device;
a first processor that determines whether the location matches a stored location associated with a location dependent communication; and
a second processor that causes the presentation of the location dependent communication, if the location matches the stored location, wherein the location dependent communication communicates more than that the location has been reached.

23. The device of claim 22 further comprising a display for displaying a visual portion of the location dependent communication.

24. The device of claim 22 further comprising an audio processing circuit coupled to the second processor to make an audible portion of the location dependent communication audible.

25. The device of claim 22 further comprising a network interface coupled to the first processor or second processor that transmits and receives communications with a network.

26. The device of claim 22 wherein the first processor and the second processor are a single physical device.
